(19) United States
(12) Patent Application Publication
(10) Pub. No.: US 2023/0055041 A1
(43) Pub. Date: Feb. 23, 2023

(54) HYBRID CORE MAGNETICS

(71) Applicants: TRUSTEES OF DARTMOUTH COLLEGE, Hanover, NH (US); MASSACHUSETTS INSTITUTE OF TECHNOLOGY, Cambridge, MA (US)

(72) Inventors: Charles R. SULLIVAN, Hanover, NH (US); David J. PERREAULT, Cambridge, MA (US)

(73) Assignees: TRUSTEES OF DARTMOUTH COLLEGE, Hanover, NH (US); MASSACHUSETTS INSTITUTE OF TECHNOLOGY, Cambridge, MA (US)

(21) Appl. No.: 17/758,918

(22) PCT Filed: Jan. 15, 2021
(86) PCT No.: PCT/US2021/013661

§ 371 Date: Jul. 15, 2022

Related U.S. Application Data
(60) Provisional application No. 62/961,991, filed on Jan. 16, 2020.

(51) Int. Cl. H01F 27/28; H01F 3/14; H01F 27/36

(52) U.S. Cl. CPC H01F 27/2895; H01F 3/14; H01F 27/363; H01F 2003/106

(57) ABSTRACT

A magnetic device, including a hybrid core including a first magnetic material as a first flux path that carries a low-frequency flux component and a second magnetic material as a second flux path that carries a high-frequency flux component that is a higher frequency flux component than the low-frequency flux component, in which the hybrid core controls distribution of the low-frequency flux component and substantially separates the low-frequency flux component and the high-frequency component; and at least one set of winding turns. The hybrid core includes at least one air gap to provide control over inductance of the magnetic device.

### TECHNICAL FIELD

The present disclosure is directed to magnetic components having hybrid core structures that incorporate and leverage multiple magnetic materials, including at least a first material that provides high permeability and high saturation flux density and a second material that provides low loss at high frequency. The high saturation flux density material carries a low frequency portion of the total magnetic flux in a compact space.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Many applications require power magnetic components such as inductors and transformers. However, fundamental scaling laws place demands for improvements in such passive components in conflict, making advances challenging. See C. R. Sullivan. B. A. Reese, A. L. Stein, and P. A. Kyaw, “On size and magnetics: Why small efficient power inductors are rare.” IEEE International Symposium on 3D Power Electronics Integration and Manufacturing (3D-PEIM), 2016, incorporated herein by reference in its entirety. In a typical application of a power magnetic component such as a pulse-width-modulated (PWM) power converter, the magnetic component stores an average amount of energy that depends on the operating point of the system and also supports a high-frequency fluctuation in its energy storage owing to the nature of the power conversion process. For example, FIG. 1A shows the typical voltage and FIG. 1B shows the typical current profile of an inductor in a PWM dc-dc converter (e.g., a buck converter). The current profile is proportional to the inductor flux linkage X and the core flux Φ_{c}(and, for a uniform core, the core flux density B_{core}). This voltage and current pattern is also representative of the magnetizing voltage and current of the power transformer of an isolated PWM power converter such as a flyback converter. The inductor or transformer in such an application must be designed to both carry the dc/low-frequency current (and associated flux) and have low loss associated with the high-frequency (e.g., with period T) variations in current and flux. The illustrated inductor current waveform is proportional to the flux linkage λ of the inductor and the inductor core flux ϕ_{c} as shown in equation (1):

Δ=N·Φ_{c}=L·i (1)

where L is the inductance, N is the number of winding turns, and i is the current. For an inductor with uniform flux density B_{c} in the core and core cross-sectional area A_{c} there is the relation B_{c}=Φ_{c}/A_{c}. Energy storage components for power applications are typically implemented with a gap to enhance the energy storage capability, with most of the energy stored in the gap rather than the magnetic core. The core provides a means to enhance the achievable inductance and energy storage by focusing the magnetic field in the core gap. FIG. 2A illustrates the structure of such a gapped power inductor and FIG. 2B illustrates its associated magnetic circuit model. The inductance of this structure is expressed as:

$$L = \frac{{N}^{2}}{{R}_{c} + {R}_{ℊ}} \qquad ( 2 )$$

where the core reluctance

$${R}_{c} \approx \frac{{l}_{c}}{{μ}_{c} {A}_{c}} ,$$

gap reluctance

$${R}_{g} \approx \frac{{l}_{ℊ}}{{μ}_{ℊ {A}_{ℊ}}} ,$$

l_{c} is the core length, l_{g} is the gap length, A_{c} is the core cross-sectional area, A_{g} is the gap cross-sectional area, μ_{c} is the core permeability, and μ_{g} is the gap permeability (usually μ₀). For the case of large permeability such that

$$\frac{{l}_{c}}{{μ}_{c}} < \frac{{l}_{ℊ}}{{μ}_{ℊ}}$$

to get an excellent approximation of the inductance as

$$\approx \frac{{N}^{2} {μ}_{ℊ} {A}_{ℊ}}{{l}_{ℊ}} .$$

This structure of a gapped power inductor and associated magnetic circuit model are useful for understanding the design constraints of conventional power inductors. In such a design, for a limited allowed size of the inductor one gets constraints on the core area A_{c} and the window area A_{w} for windings (which may be traded off between each other to a limited extent). The achievable flux linkage is limited by the core area and allowable saturation flux density of the core Bₛₐₜ:

λ=L·I<NBₛₐₜA_{c} (3)

which in turn limits achievable energy storage. The dc resistance of the inductor R_{dc} is limited by the copper resistivity ρ_{cu}, window area A_{w}, number of turns N, and the mean length of a turn (mlt), which is monotonic with the core cross sectional area:

$${R}_{dc} \geq \frac{{N}^{2} {ρ}_{cu} mlt}{{A}_{w}} \qquad ( 4 )$$

### SUMMARY

In an exemplary embodiment, a magnetic device, including: a hybrid core including a first magnetic material as a first flux path that carries a low-frequency flux component and a second magnetic material as a second flux path that carries a high-frequency flux component that is a higher frequency flux component than the low-frequency flux component, in which the hybrid core controls distribution of the low-frequency flux component and substantially separates the low-frequency flux component and the high-frequency component; and at least one set of winding turns. The hybrid core includes at least one air gap to provide control over inductance of the magnetic device.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a graph of a voltage and FIG. 1B is a graph of current profile of an inductor in a PWM dc-dc converter;

FIG. 2A illustrates a structure of a typical gapped power inductor and FIG. 2B illustrates a magnetic circuit model for the gapped power inductor;

FIGS. 3A, 3B, and 3C illustrate a toroidal inductor implementation in accordance with an exemplary aspect of the disclosure, where FIG. 3A is a bottom view of the inductor, FIG. 3B is a cross section through the middle of the inductor, and FIG. 3C is a gap-end view of the inductor;

FIG. 4A illustrates a magnetic circuit model for the inductor structure of FIG. 3A;

FIG. 4B illustrates an electrical model for the inductor structure of FIG. 3A;

FIG. 5 illustrates a pot-core inductor implementation in accordance with an exemplary aspect of the disclosure;

FIG. 6 illustrates a cross-section of an exemplary hybrid core structure in accordance with an exemplary aspect of the disclosure; and

FIG. 7 illustrates a toroidal inductor with hybrid core in which the different sections of the hybrid core have different, partially-shared effective gaps.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

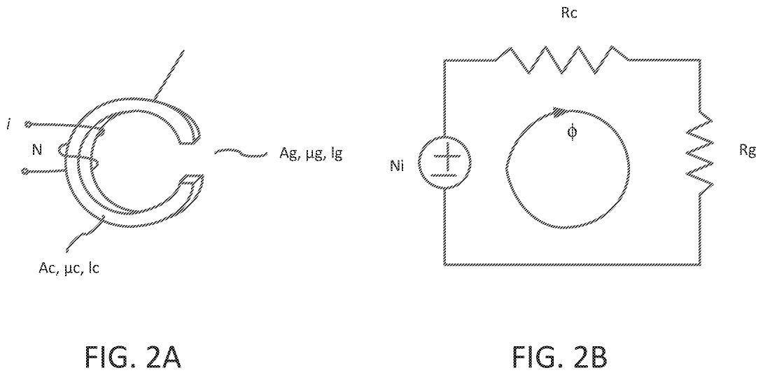

It is one object of the present disclosure to describe a system and method that provides (1) high peak energy storage/flux linkage in a given volume, (2) low DC conduction losses/low DC resistance, and (3) low AC-related losses including low conduction and core loss for high-frequency portions of current and flux. There is a need for new approaches for power magnetic components that can better accommodate improved size, efficiency and frequency capability.

Where it is desired to get both high energy storage and low resistance, tradeoffs among the available design variables (core area, window area, numbers of turns) provide a fixed constraint given limitations on the saturation flux density Bₛₐₜ and permeability μ_{c} of available core materials. Further limiting the tradeoffs are losses associated with AC components: skin and proximity effects yield much higher conduction losses for AC currents than suggested by the DC resistance. Moreover, the conductivity and core loss of the core material can impose significant additional losses and prevent effective core use at high frequencies. Unfortunately, as illustrated in Table 1, those core materials providing the highest permeabilities and, more importantly, the highest saturation flux densities (enabling high DC flux linkage and energy storage in a given volume) also have low resistivity and hence unacceptable performance for high frequency waveform components. As a result, meeting all of the goals of (1) small size, (2) high efficiency/small resistance, and (3) high frequency is severely constrained with conventional designs based on the structure of FIG. 2A and available materials as illustrated in Table 1. See [2] J. G. Kassakian, M. F. Schlecht, and G. C. Verghese, Principles of Power Electronics, 1991, Ch. 20; [3] A. J. Hanson, J. A. Belk, S. Lim, C. R. Sullivan, and D. J. Perreault, “Measurements and Performance Factor Comparisons of Magnetic Materials at High Frequency,” IEEE Transactions on Power Electronics, Vol. 31, No. 11, pp. 7909-7925, November 2016, each incorporated herein by reference in their entirety.

TABLE 1
Characteristics of example magnetic materials

| | Bₛₐₜ | μ | ρ | |
|---|---|---|---|---|
| Material | (T) | (μ₀) | (μΩ-cm) | Source(s) |
| Low-Si iron | 2.2 | 2.7 × 10³ | 10 | [2] |
| (0.25%) | | | | |
| Core iron (1%) | 2.1 | 4.5 × 10³ | 25 | [2] |
| Si steel (2.5%) | 2.0 | 5 × 10³ | 40 | [2] |
| 48% Ni Alloy | 1.5 | 4 × 10⁴ | 48 | [2] |
| 80% Ni, 4% Mo | 0.8 | 5 × 10⁴ | 58 | [2] |
| Alloy | | | | |
| 50% Co Alloy | 2.3 | 10⁴ | 35 | [2] |
| Ferrite | ~0.4-0.8 | 1-4 × 10³ | High | [2], [3] |
| (Mn—Zn) | | | | |
| Ferrite | ~0.3 | 0.01-1 × 10³ | High | [2], [3] |
| (Ni—Zn) | | | | |

One solution may be to construct a magnetic core with a combination of different core materials. Magnetic cores have been constructed with combinations of different core materials, arranged to provide parallel flux paths. See M. Mu, W. Zhang, F. C. Lee and Y. Su, “Laminated low temperature co-fired ceramic ferrite materials and the applications for high current POL converters,” 2013 IEEE Energy Conversion Congress and Exposition, Denver, Colo., 2013, pp. 621-627; L. Wang, Z. Hu, Y. Liu, Y. Pei, X. Yang and Z. Wang, “A Horizontal-Winding Multipermeability LTCC Inductor for a Low-profile Hybrid DC/DC Converter,” in IEEE Transactions on Power Electronics, vol. 28, no. 9, pp. 4365-4375, September 2013; L. Wang, Z. Hu, Y. Liu, Y. Pei and X. Yang, “Multipermeability Inductors for Increasing the Inductance and Improving the Efficiency of High-Frequency DC/DC Converters,” in IEEE Transactions on Power Electronics, vol. 28, no. 9, pp. 4402-4413, September 2013, each incorporated herein by reference in their entirety. However, these designs are different in construction, intent, and function. These designs do not significantly direct low-frequency (or DC) flux through a different path than the high-frequency flux: both paths carry both low-frequency and high-frequency flux. The purpose in these prior art works of using more than one material is to control the decline in inductance as high flux density causes saturation. The higher-permeability material saturates first, leaving the low-permeability material still able to contribute to inductance. The result is that the inductance doesn't drop off at high currents as much as it would with only the higher permeability material, but the inductance at low currents is higher than it would be with only the lower permeability material. These works of using more than one material are not able to maintain the initial inductance at high current levels, and these works require both materials to work well at frequency.

Another solution may be an inductor for electromagnetic interference control that uses two magnetic cores providing parallel flux paths. The inductor may be assembled from two stacked toroids. See M. Kącki, M. S. Rylko, J. G. Hayes and C. R. Sullivan, “Magnetic material selection for EMI filters,” 2017 IEEE Energy Conversion Congress and Exposition (ECCE), Cincinnati, Ohio, 2017, pp. 2350-2356, incorporated herein by reference in its entirety. Both magnetic cores are ferrite; one a MnZn ferrite good for the range of 10s of kHz through a few MHz, and the other a NiZn material that performs best at higher frequencies. The design shown is a common-mode choke in which saturation is avoided by having the MMF produced by different windings cancel. Other than the common mode application, it would be unable to handle substantial currents without saturation, because the high-permeability, ungapped MnZn core would quickly saturate.

None of M. Mu et al., L. Wang et al. (2013-1), L. Wang et al. (2013-2), and M. Kacki et al. use a common airgap for the flux through the two different materials, and none use currents induced in a shorted winding or a conductive magnetic material to block high-frequency flux from flowing through a core path intended to be used for low-frequency flux.

Multiple magnetic materials with different characteristics have also been deployed in series through the magnetic path in an inductor. See for example, W. M. Chew, P. D. Evans and W. J. Heffernan, “High frequency inductor design concepts,” PESC '91 Record 22nd Animal IEEE Power Electronics Specialists Conference, Cambridge, Mass., USA, 1991, pp. 673-678, incorporated herein by reference in its entirety. In this example, as in other similar designs, the concept is to replace the reluctance of an air gap with the same reluctance spread over a longer length of the core path through the use of a low-permeability magnetic material.

This affects the field shape in the winding region and can reduce winding losses, but both materials must handle the full low frequency and high frequency flux components.

Aspects of this disclosure are directed to magnetic components (including inductors, coupled inductors, and transformers) that achieve (1) high peak energy storage/flux linkage in a given volume, (2) low dc conduction losses/low dc resistance, and (3) low ac-related losses including low conduction and core loss for high-frequency portions of current and flux.

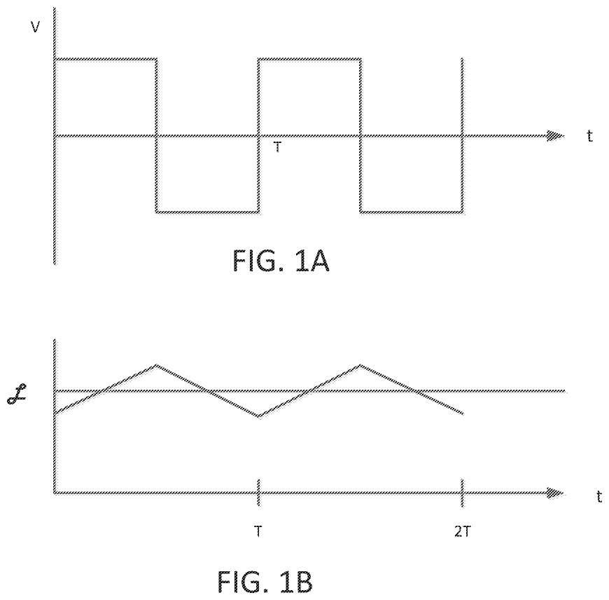

These magnetic components are particularly well suited for applications having waveforms with large low-frequency (e.g., dc) flux along with high-frequency flux ripple, such as illustrated in FIGS. 1A, 1B. The applications are accomplished in part through hybrid core structures that incorporate and leverage multiple magnetic materials, including at least a first one that provides high permeability and high saturation flux density (e.g., such as a steel) and a second one that provides low loss at high frequency (e.g., such as a ferrite). The magnetic component is structured to utilize the high saturation flux density material to dominantly carry the large, low-frequency portion of the total magnetic flux in a compact space, while utilizing the high-frequency material to dominantly carry the high-frequency ac portion of the total magnetic flux with low loss. Distribution of low-frequency magnetic flux and separation of the different frequency components of magnetic flux can be controlled using the properties (e.g., conductivity and permeability) of the magnetic materials themselves, including use of magnetic diffusion between the materials. Alternatively or in addition, additional layer(s) of material (including conductors and/or insulators and/or semiconductors and/or superconductors) and/or windings (possibly connected to components) can be placed (e.g., between the magnetic materials) to control the distribution and transfer of different flux components among the multiple materials. One or more gaps in the magnetic structure (preferably at least partially common to the multiple flux paths through the magnetic materials) can be utilized to provide desired control over inductance and energy storage.

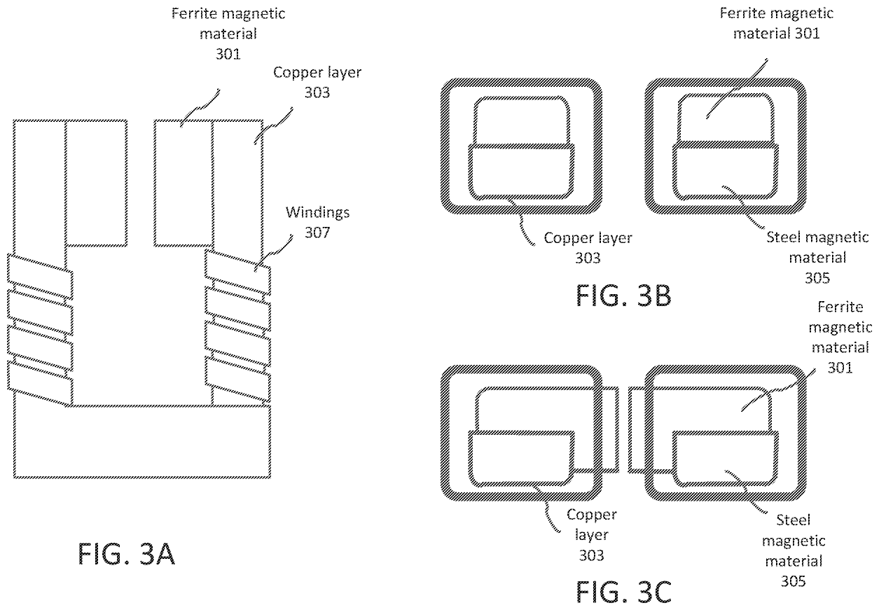

FIGS. 3A, 3B, and 3C illustrate a toroidal inductor implementation in accordance with an exemplary aspect of the disclosure, where FIG. 3A is a bottom view of the inductor, FIG. 3B is a cross section through the middle of the inductor, FIG. 3C is a gap-end view of the inductor. A troidal core is based on a toroid (the same shape as a doughnut). The coil is wound through the hole in the torus and around the outside. The symmetry of this geometry creates a magnetic field of circular loops inside the core, and the lack of sharp bends will constrain virtually all of the field to the core material. The implementation leverages a stacked steel core and ferrite core with a copper layer around the steel core section for control of flux distribution. The implementation includes a steel magnetic material 305, ferrite magnetic material 301, copper used for the “shield” for flux distribution control 303, and magnetic windings 307.

The gapped toroidal inductor is implemented such that flux is linked by a set of winding turns and through a gap by a hybrid steel and ferrite core, with a copper layer around the steel portion of the core to control distribution of different frequency components of magnetic flux between the core sections. The hybrid core may be formed by plating the steel core with copper, and stacking a ferrite section on top of the steel section. (Alternatively, a steel core completely surrounded by a ferrite section could be utilized, with or without the copper layer between them. In the case where a copper layer is not utilized, the conductivity of the steel itself would be employed to shield ac flux from that section of the core.) Also, while not shown, the steel core section may comprise laminated steel subsections to control eddy currents within it. Likewise, while not shown, the ferrite core section may include distributed gaps enabling the effective permeability of the ferrite core section to be controlled.

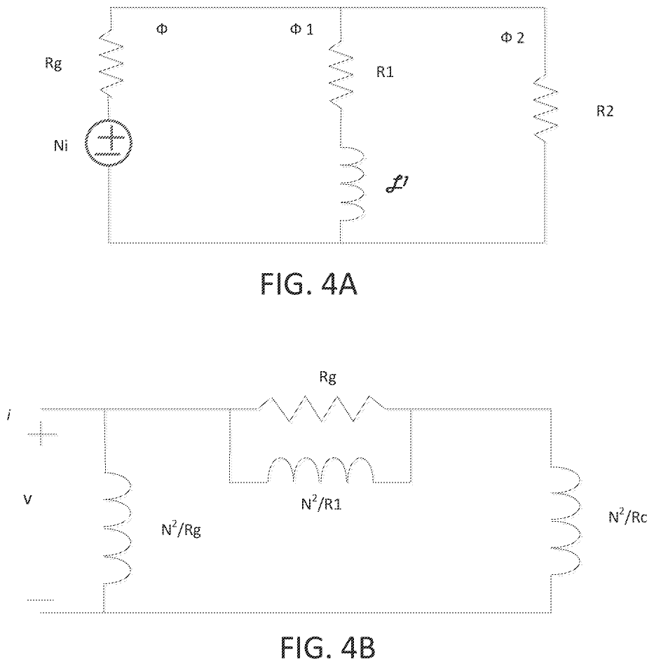

FIG. 4A illustrates a magnetic circuit model for the inductor of FIG. 3. R_{g} represents the reluctance of the gap

$$( flux path Φ = \frac{1}{N} \int Vdt ) ,$$

R₂ represents the reluctance of the flux path Φ₂, through the ferrite core section, R₁ represents the reluctance of the flux path Φ₂ through the steel core section, and [symbol] ₁ represents the transference associated with the “shield” copper layer shorting around the steel section, where the value of [symbol] ₁ equals the resistance of the copper path shorting the steel core section. See E. R. Laithwaite, “Magnetic Equivalent Circuits for Electric Machines,” Proceedings of the IEEE,

Vol. 114, No. 11, pp. 1805-1809, November 1967, incorporated herein by reference in its entirety. (A more sophisticated model may include multiple parallel-connected branches of series-connected reluctances and transferences to capture details of the magnetic diffusion within the steel core section and/or the copper. The model could also be elaborated to include nonlinearity in the reluctances representing each core material for designs that drive them into partial saturation.)

The effect of the magnetic structure on flux distribution within the core can be seen from the model of FIG. 4A: At DC (and very low frequencies), the transference element has no effect on flux distribution, and flux is distributed in the core according to the reluctances of the ferrite and steel sections. If the steel section has much lower reluctance than the ferrite section, then it will carry the majority of the dc flux.

Thus, one can take advantage of the high permeability and saturation flux density of the steel section to carry the low-frequency flux components with small reluctance at small size. Conversely, at high frequencies, the transference element causes the steel branch to present a very high “concedance” (or “magnetic impedance”) to flux. Thus, the majority of the high-frequency ac flux will be carried in the ferrite section of the core, which exhibits low core loss for these ac components. How flux will be carried in the hybrid core in the time and frequency domains can be inferred from this magnetic circuit.

FIG. 4B shows a simplified electric circuit model for the inductor of FIG. 3 that includes the flux-splitting effects of the hybrid core and shield, and includes a resistive element that models the eddy-current loss in the shield copper. (Other loss components, including winding conduction loss and core loss are not included in this model, but could be through approximate inclusion of additional elements.) For the case where the gap represents the dominant reluctance in the system, the effective inductance of this magnetic structure is very close to L≈N/R_{g}. The dynamics of flux distribution within the core can likewise be inferred from the different magnetizing components in the electric circuit model.

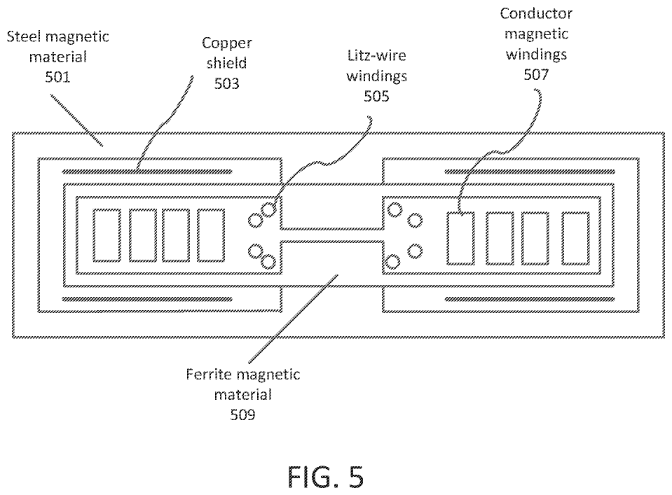

It will be appreciated that there are many other implementations of the proposed invention that can be realized. An example pot-core inductor implementation of the proposed invention is shown in FIG. 5. The shape of a pot core is round with an internal hollow that almost completely encloses the coil. A pot core may be made in two halves which fit together around a coil former (bobbin). The implementation leverages an outer high-permeability steel shell 501 and an inner ferrite pot core 509 with an extra-wide centerpost. Copper shield rings 503 are provided to limit penetration of ac flux to the outer steel section 501. Moreover, high frequency litz windings 505 are placed in parallel with low-frequency solid rectangular windings 507, such that the litz windings 505 can handle the high-frequency current components, while low-frequency currents are carried in the solid conductors. As with the toroidal core inductor, the hybrid magnetic core is structured is that the entire magnetic field can diffuse into the ferrite core portion, while only low-frequency field components diffuse into the steel section of the core. Likewise, both core paths share at least a portion of the gap in common. It will be appreciated that this implementation may also be modeled with the simplified magnetic and electric circuit models of FIGS. 4A and 4B.

There are many variants consistent with the present invention. While the examples of FIGS. 3A, 3B, 3C, and 5 are inductors, transformers and coupled inductors utilizing these underlying concepts can be implemented by having multiple winding sets. Likewise, while the illustrated designs show single major core flux paths, it is possible to have designs with multiple significant core flux paths and multiple effective gaps, as is often done with coupled magnetic structures.

The shield “layer” that keeps high-frequency flux out of the low-frequency core path may be a continuous layer placed or deposited around the core, as in FIGS. 3A, 3B, 3C, or it may a winding comprising one or more shorted turns. In FIG. 5, for example, it is two separate windings, each forming a single shorted turn.

The application illustrated in FIG. 1 includes a current with dc low-frequency component and a triangular high-frequency component, and thus produces a flux waveform with corresponding components.

Different applications may have different high- and low-frequency components, and may have important components in more than two frequency ranges. The invention applies to these as well. For example, many applications have a line frequency component at 50, 60, 100, or 120 Hz plus a high-frequency component. An implementation for such an application will be very similar, with a few additional considerations to ensure good performance and low losses for the line frequency component: a steel core component will typically use laminated steel rather than solid steel to reduced eddy currents for this component. And the resistance of the conductive shield layer or winding that keeps high-frequency flux out of the low-frequency core path needs to be carefully tuned to allow low-frequency flux without excessive winding loss, and to block high-frequency flux, again without excessive winding loss, whereas in an application with dc flux as the low-frequency component, there is no harm in having a very low shield resistance.

An option to reduce low-frequency current in the shield winding is to connect the winding (which comprises one or more turns) to a capacitor instead of shorting the winding, with the capacitor selected to have a high impedance for the low-frequency component and a low-impedance for the high frequency component. Higher-order LC networks may also be used for a sharper transition between high and low impedance.

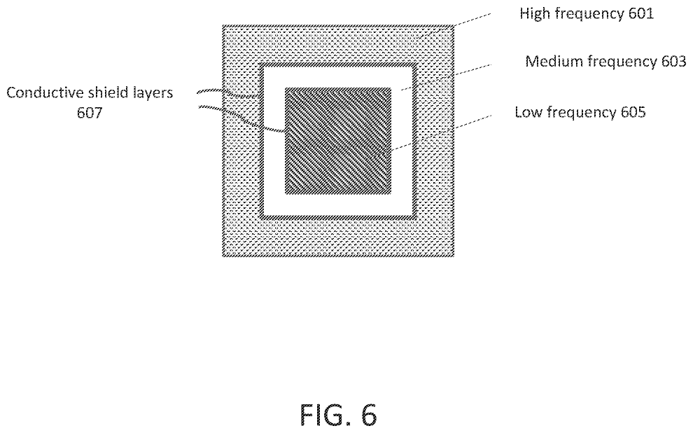

It is also possible to use more than two disparate core materials (and/or more than two “layers” of core material. For example, FIG. 6 illustrates a hybrid core structure having three separate magnetic layers. The innermost magnetic layer 605 may have the highest permeability, the highest saturation flux density and lowest frequency capability (for example, iron). A middle magnetic layer 603 may have one or more of moderate permeability, moderate saturation flux density and moderate frequency capability (for example, a nanocrystalline material). The outer magnetic layer 601 may have one or more of low permeability, low saturation flux density and high frequency capability (for example, ferrite). The magnetic layers may be separated by conductive shields 607 to control flux separation among layers. Moreover, such magnetic structures may include hard magnetic materials to enable pre-biasing for higher dc flux carrying capability (See, for example, S. Lin, J. Friebe, S. Langfermann, and M. Owzareck, “Premagnetization of High-Power Low-Frequency DC0Inductors for Power Electronic Applications,” PCIM Europe 2019, incorporated herein by reference in its entirety).

It will be appreciated that fabrication of such multi-layer core structures (two or more layers) can be realized through a variety of means, including simple mechanical assembly as well as the use of electroplating, sputtering, evaporation, electrostatic spray, gluing, pressing, sintering, etc. Also note that additional layers may be incorporated for non-magnetic purposes including holding parts together, electrical insulation, thermal management (e.g. heat conduction), accommodating or matching thermal expansion, Likewise, windings may be formed through a variety of means, including winding, plating and etching, stamping, implementation via printed circuit board, etc., using a variety of conductor materials including copper, aluminum, and combinations of copper and aluminum.

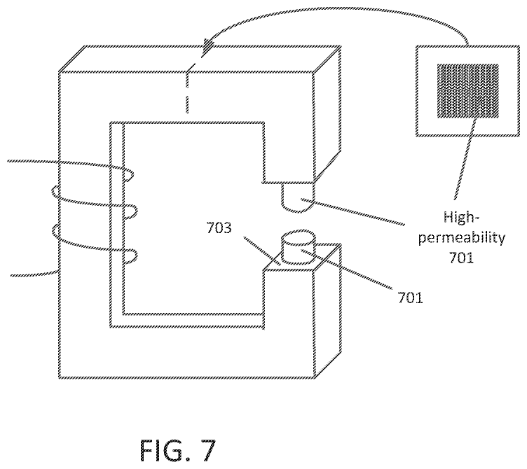

It will be recognized that termination of different segments of hybrid core structures at a common gap can be realized in various ways. In addition to having partially shared paths (e.g., through one of the magnetic materials) leading to a common gap, special terminating structures may be used in which different core sections have different effective gaps. For example, FIG. 7 illustrates one such possibility in which the high-permeability core section 701 extends further into a gap space than the low-permeability section 703. Likewise, in addition to common gaps, different core segments may have different gaps, for example used to control effective permeabilities or flux carrying of different sections. Distributed gapping may likewise be utilized to control (e.g., balance) the effective reluctances appearing for high-frequency current components, such that double-sided conduction may be realized for high-frequency current components (see, for example, R. S. Yang, A. J. Hanson, R. Bradley, C. R. Sullivan, and D. J. Perreault “A Low-Loss Inductor Structure and Design Guidelines for High-Frequency Applications,” IEEE Transactions on Power Electronics, (in press), incorporated herein by reference in its entirety.)

Numerous modifications and variations of the present invention are possible in light of the above teachings. It is therefore to be understood that within the scope of the appended claims, the invention may be practiced otherwise than as specifically described herein.

The above disclosure also encompasses the embodiments listed below.

(1) A magnetic device, includes a hybrid core includes a first magnetic material as a first flux path that carries a low-frequency flux component and a second magnetic material as a second flux path that carries a high-frequency flux component that is a higher frequency flux component than the low-frequency flux component, in which the hybrid core controls distribution of the low-frequency flux component and substantially separates the low-frequency flux component and the high-frequency component; and at least one set of winding turns. The hybrid core includes at least one air gap to provide control over inductance of the magnetic device.

(2) The magnetic device of feature (1), in which the hybrid core is in a form of a loop, the first magnetic material is steel and the second magnetic material is ferrite stacked on the first magnetic material, and the at least one set of winding turns is a copper layer on the steel that controls distribution of the frequency components between the first magnetic material and the second magnetic material.

(3) The magnetic device of features (1) or (2), in which the hybrid core is in a form of a loop, the first magnetic material is steel and the second magnetic material is ferrite, the steel portion of the core is substantially surrounded by the ferrite, and a conductivity of the steel provides a shield for the high-frequency flux component.

(4) The magnetic device of any of features (1) to (3), in which the hybrid core is in a form of a loop, the first magnetic material is steel and the second magnetic material is ferrite, and the steel portion of the hybrid core comprises laminated steel subsections to control eddy currents.

(5) The magnetic device of any of features (1) to (4), in which the hybrid core is in a form of a loop, the at least one air gap includes a plurality of air gaps, and the plurality of air gaps controls permeability in the second magnetic material portion.

(6) The magnetic device of any of features (1) to (5), in which the hybrid core is in a form of a substantially round enclosure including the first magnetic material in the form of an outer high-permeability steel shell, and the second magnetic material in the form of an inner ferrite pot core with a center post.

(7) The magnetic device of any of feature (6), further includes copper shield rings provided to limit penetration of the high-frequency flux component to the outer steel section.

(8) The magnetic device of any of features (1) to (7), in which the hybrid core includes more than two magnetic materials as respective core flux paths, and the at least one air gap includes a plurality of air gaps.

(9) The magnetic device of any of features (1) to (8), in which the at least one set of winding turns includes at least one shorted turn.

(10) The magnetic device of any of features (1) to (9), in which the high-frequency flux component is a frequency that is at least one hundred times higher than the low-frequency flux component.

(11) The magnetic device of any of features (1) to (10), in which the first magnetic material is laminated steel.

(12) The magnetic device of any of features (1) to (11), in which a resistance of the at least one set of winding turns is sufficient to keep the high-frequency flux component separate from the low-frequency component such that the high-frequency flux component is kept out of the first flux path, high-frequency flux component losses are minimized, losses resulting from low-frequency excitations are minimized, and blocking of the low-frequency flux component from the first flux path is avoided.

(13) The magnetic device of feature (12), in which the low-frequency flux component is DC flux, the high-frequency flux component is an AC component, and the winding turns are formed with lower resistance than resistance of winding turns necessary to shield a frequency of the AC component.

(14) The magnetic device of any of features (1) to (13), further includes a capacitor connected to the at least one set of winding turns.

(15) The magnetic device of any of features (1) to (6), further includes high frequency Litz windings, in which the at least one set of windings are low-frequency solid windings, and the Litz windings are arranged in parallel with the low-frequency solid windings such that the Litz windings handle the high-frequency component, while low-frequency currents are carried in the solid windings.

(16) The magnetic device of feature (15), in which a higher-order LC network is used for the transition between the high and low impedance.

(17) The magnetic device of any of features (1) to (16), in which the hybrid core includes more than two magnetic material layers as respective core flux paths, an innermost magnetic material layer has a highest flux density and a lowest frequency component, and an outer magnetic material layer has the lowest flux density and a highest frequency component, and the magnetic material layers are separated by conductive shields to control flux separation among the layers.

(18) The magnetic device of any of features (1) to (17), in which the at least one air gap includes a first air gap in the first magnetic material of the hybrid core and a second air gap in the second magnetic material of the hybrid core, the first air gap being different from the second aid gap.

(19) The magnetic device of feature (18), in which the first air gap in the first magnetic material is smaller than the second air gap in the second magnetic material.

(20) The magnetic device of feature (18), the first air gap in the first magnetic material of the hybrid core is arranged at a different position than the second air gap in the second magnetic material of the hybrid core.

1. A magnetic device, comprising:
a hybrid core including a first magnetic material as a first flux path that carries a low-frequency flux component and a second magnetic material as a second flux path that carries a high-frequency flux component that is a higher frequency flux component than the low-frequency flux component, wherein the hybrid core controls distribution of the low-frequency flux component and substantially separates the low-frequency flux component and the high-frequency component; and
at least one set of winding turns, wherein
the hybrid core includes at least one air gap to provide control over inductance of the magnetic device.

2. The magnetic device of claim 1, wherein
the hybrid core is in a form of a loop,
the first magnetic material is steel and the second magnetic material is ferrite stacked on the first magnetic material, and
the at least one set of winding turns is a copper layer on the steel that controls distribution of the frequency components between the first magnetic material and the second magnetic material.

3. The magnetic device of claim 1, wherein
the hybrid core is in a form of a loop,
the first magnetic material is steel and the second magnetic material is ferrite,
the steel portion of the core is substantially surrounded by the ferrite, and
a conductivity of the steel provides a shield for the high-frequency flux component.

4. The magnetic device of claim 1, wherein
the hybrid core is in a form of a loop,
the first magnetic material is steel and the second magnetic material is ferrite, and
the steel portion of the hybrid core comprises laminated steel subsections to control eddy currents.

5. The magnetic device of claim 1, wherein
the hybrid core is in a form of a loop,
the at least one air gap includes a plurality of air gaps, and
the plurality air gaps controls permeability in the second magnetic material portion.

6. The magnetic device of claim 1, wherein the hybrid core is in a form of a substantially round enclosure including the first magnetic material in the form of an outer high-permeability steel shell, and the second magnetic material in the form of an inner ferrite pot core with a center post.

7. The magnetic device of claim 6, further comprising:
copper shield rings provided to limit penetration of the high-frequency flux component to the outer steel section.

8. The magnetic device of claim 1, wherein
the hybrid core includes more than two magnetic materials as respective core flux paths, and
the at least one air gap includes a plurality of air gaps.

9. The magnetic device of claim 1, wherein the at least one set of winding turns includes at least one shorted turn.

10. The magnetic device of claim 1, wherein the high-frequency flux component is a frequency that is at least one hundred times higher than the low-frequency flux component.

11. The magnetic device of claim 1, wherein the first magnetic material is laminated steel.

12. The magnetic device of claim 1, wherein a resistance of the at least one set of winding turns is sufficient to keep the high-frequency flux component separate from the low-frequency component such that
the high-frequency flux component is kept out of the first flux path,
high-frequency flux component losses are minimized,
losses resulting from low-frequency excitations are minimized, and
blocking of the low-frequency flux component from the first flux path is avoided.

13. The magnetic device of claim 12, wherein the low-frequency flux component is DC flux, the high-frequency flux component is an AC component, and the winding turns are formed with lower resistance than resistance of winding turns necessary to shield a frequency of the AC component.

14. The magnetic device of claim 1, further comprising:
a capacitor connected to the at least one set of winding turns.

15. The magnetic device of claim 6, further comprising:
high frequency Litz windings, wherein
the at least one set of windings are low-frequency solid windings, and
the Litz windings are arranged in parallel with the low-frequency solid windings such that the Litz windings handle the high-frequency component, while low-frequency currents are carried in the solid windings.

16. The magnetic device of claim 15, wherein a higher-order LC network is used for the transition between the high and low impedance.

17. The magnetic device of claim 1, wherein
the hybrid core includes more than two magnetic material layers as respective core flux paths,
an innermost magnetic material layer has a highest flux density and a lowest frequency component, and an outer magnetic material layer has the lowest flux density and a highest frequency component, and
the magnetic material layers are separated by conductive shields to control flux separation among the layers.

18. The magnetic device of claim 1, wherein the at least one air gap includes a first air gap in the first magnetic material of the hybrid core and a second air gap in the second magnetic material of the hybrid core, the first air gap being different from the second aid gap.

19. The magnetic device of claim 18, wherein the first air gap in the first magnetic material is smaller than the second air gap in the second magnetic material.

20. The magnetic device of claim 18, wherein the first air gap in the first magnetic material of the hybrid core is arranged at a different position than the second air gap in the second magnetic material of the hybrid core.
